(19) United States
(12) Patent Application Publication
(10) Pub. No.: US 2026/0239467 A1
(43) Pub. Date: Aug. 13, 2026

(54) DUPLICATION TRANSMISSION METHOD AND DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Xinlei YU, Dongguan (CN); Zhe FU, Dongguan (CN)

(73) Assignee: GUANGDONG OPPO MOBILE TELECOMMUNICATIONS CORP., LTD., Dongguan (CN)

(21) Appl. No.: 19/638,713

(22) Filed: Apr. 3, 2026

Related U.S. Application Data
(63) Continuation of application No. PCT/CN2023/136561, filed on Dec. 5, 2023.

(51) Int. Cl. H04W 76/15; H04L 1/08; H04W 80/02

(52) U.S. Cl. CPC H04W 76/15; H04L 1/08; H04W 80/02

(57) ABSTRACT

Embodiments of the present application provide a duplication transmission method, applied to a first device, there being one or more paths between the first device and a second device, and there being one or more relay terminal devices on each path. The method includes: acquiring first information, the first information being used for determining whether to activate a packet data convergence protocol (PDCP) duplication transmission mechanism of the first device, and the PDCP duplication transmission mechanism being used for the first device to send first data to the second device.

### CROSS-REFERENCE TO RELATED APPLICATION

The present application is a continuation of International Application No. PCT/CN2023/136561 filed on Dec. 5, 2023, the disclosure of which is hereby incorporated by reference in its entirety.

### BACKGROUND

In a UE to Network (U2N) relay scenario, each path between a remote terminal and a network may be a non-direct path, which may effectively improve reliability and throughput of data transmission for terminals outside network coverage. However, since there is no direct path between the remote terminal and the network, it is necessary to solve a problem of how to activate a Packet Data Convergence Protocol (PDCP) duplication transmission mechanism in this scenario.

### SUMMARY

Embodiments of the present application relate to the technical field of communication.

Embodiments of the present application provide a method and apparatus, a device, a chip, and a storage medium for duplication transmission.

According to a first aspect, an embodiment of the present application provides a duplication transmission method, which is applied to a first device. One or multiple paths exist between the first device and a second device, and one or more relay terminal devices exist on each path, and the method includes the following operations: first information is acquired, the first information is used to determine whether to activate a packet data convergence protocol (PDCP) duplication transmission mechanism of the first device, and the PDCP duplication transmission mechanism is used for the first device to transmit first data to the second device.

According to a second aspect, an embodiment of the present application provides a duplication transmission method, which is applied to a second device. One or multiple paths exist between a first device and the second device, and one or more relay terminal devices exist on each path, and the method includes an operation that: first information is transmitted to the first device, the first information is used to determine whether to activate a packet data convergence protocol (PDCP) duplication transmission mechanism of the first device, and the PDCP duplication transmission mechanism is used for the first device to transmit first data to the second device.

According to a third aspect, an embodiment of the present application provides a communication device including a processor and a memory. The memory is used to store a computer program, and the processor is configured to invoke and execute the computer program stored in the memory to perform the method of any one of the first aspects.

### BRIEF DESCRIPTION OF THE DRAWINGS

The drawings described herein are intended to provide a further understanding of the present application, and constitute a part of the present application. The schematic embodiments of the present application and the description thereof are intended to explain the present application, and do not constitute an unsuitable limitation of the present application. In the drawings:

FIG. 1A is a schematic diagram of resource selection corresponding to a first mode according to an embodiment of the present application.

FIG. 1B is a schematic diagram of resource selection corresponding to a second mode according to an embodiment of the present application.

FIG. 2 is a schematic diagram of a user plane protocol stack of a sidelink L2 U2N relay architecture according to an embodiment of the present application.

FIG. 3 is a schematic diagram of a user plane protocol stack of an L2 multipath relay based on a sidelink according to an embodiment of the present application.

FIG. 4 is a schematic diagram of an example of a user plane protocol stack in a multipath U2N relay scenario according to an embodiment of the present application.

FIG. 5 is a schematic flowchart of a duplication transmission method according to an embodiment of the present application.

FIG. 6 is a schematic diagram of an example of a format of a PDCP control Protocol Data Unit (PDU) according to an embodiment of the present application.

FIG. 7 is a schematic flowchart of activating/deactivating a PDCP duplication transmission mechanism according to a control signalling according to an embodiment of the present application;

FIG. 8 is a schematic diagram of an example of a format of a Media Access Control (MAC) Control Element (MAC CE) transmitted by a network according to an embodiment of the present application.

FIG. 9 is a schematic diagram of an example of a format of a Radio Link Control (RLC) control PDU or an Sidelink Relay Adaptation Protocol (SRAP) control PDU transmitted by a network according to an embodiment of the present application.

FIG. 10 is a schematic diagram of an example of a format of an RLC control PDU or an SRAP control PDU transmitted by a relay terminal according to an embodiment of the present application;

FIG. 11 is a schematic structural diagram of a duplicate transmission apparatus according to an embodiment of the present application.

FIG. 12 is a second schematic structural diagram of a duplicate transmission apparatus according to an embodiment of the present application.

FIG. 13 is a third schematic structural diagram of a duplication transmission apparatus according to an embodiment of the present application.

FIG. 14 is a schematic structural diagram of a communication device according to an embodiment of the present application.

FIG. 15 is a schematic structural diagram of a chip according to an embodiment of the present application.

### DETAILED DESCRIPTION

Hereinafter, technical solutions in embodiments of the present application will be described with reference to the accompanying drawings in the embodiments of the present application. It is obvious that the described embodiments are part of the embodiments of the present application, but not all the embodiments. Based on the embodiments in the present application, all other embodiments obtained by those skilled in the art without creative work fall within the scope of the present application.

The technical solutions in the embodiments of the present application can be applied to various sidelink communication systems. In order to facilitate understanding of the technical solutions in the embodiments of the present application, related technologies of the embodiments of the present application will be described below, and the related technologies below as optional solutions can be arbitrarily combined with the technical solutions in the embodiments of the present application, and all of them belong to the scope of the embodiments of the present application.

### 1. Device to Device (D2D)/Vehicle to Everything (V2X) in Long Term Evolution (LTE)

Device-to-device communication is a Sidelink (SL) transmission technology based on D2D. Different from a traditional cellular system in which communication data is received or transmitted through a base station, a Vehicle to Everything system uses terminal-to-terminal direct communication, so it has higher spectral efficiency and lower transmission delay. Two transmission modes are defined in the 3rd Generation Partnership Project (3GPP): a first mode (mode 3) and a second mode (mode 4).

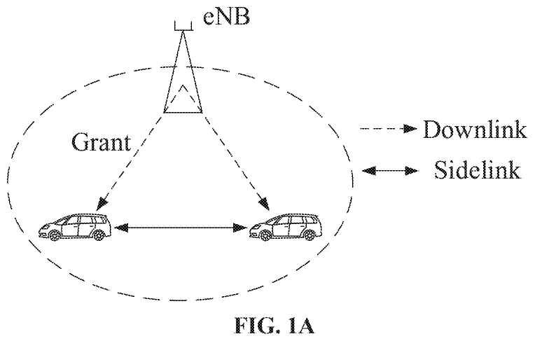

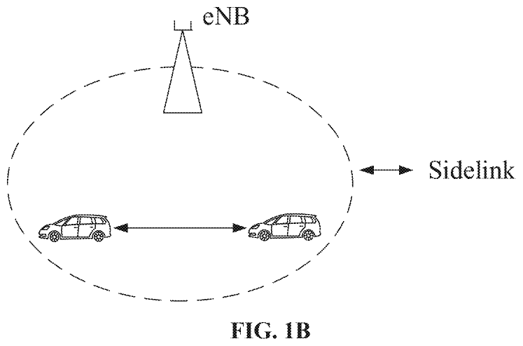

In the first mode, transmission resources of the terminal are allocated by a base station (eNB), and the terminal transmits data on a sidelink according to the resources allocated by the base station. The base station may allocate resources for single transmission to the terminal, or may allocate resources for semi-persistent transmission to the terminal. As shown in FIG. 1A, the transmission resources of the terminal are allocated by the base station, the base station allocates resources to the terminal based on a grant signalling through a downlink, and the terminal transmits data on a sidelink according to the resources allocated by the base station.

In the second mode, the terminal selects a resource from a resource pool for data transmission. As shown in FIG. 1B, the terminal selects a resource from a resource pool for data transmission.

In the 3GPP, D2D is studied by divided it into the following different phases:
1) Proximity based Service (ProSe): In the Rel-12/13, device-to-device communication is studied for ProSe scenarios, which are mainly used for public safety services.

In the ProSe, by configuring a position of a resource pool in the time domain, for example, the resource pool is discontinuous in the time domain, the UE can discontinuously transmit/receive data on the sidelink, thereby achieving the effect of power saving.
2) V2X: In the Rel-14/15, in the Vehicle to Vehicle to Everything system, vehicle-to-vehicle communication scenarios are studied, which are mainly used for relatively high-speed moving vehicle-to-vehicle and vehicle-person communication services.

In the V2X, because the in-vehicle system has continuous power supply, the main problem is not power efficiency, but the delay of data transmission. Therefore, the system design requires the terminal device to perform continuously transmitting and receiving.
3) Wearable devices (FeD2D): In the Rel-14, it studies the scenario in which wearable devices access a network through mobile phones, which is mainly used for scenarios with low moving speed and low power access.

In the FeD2D, in the pre-research stage, 3GPP concluded that the base station can configure a Discontinuous Reception (DRX) parameter for a remote terminal through a relay terminal, but did not give a conclusion on the specific details of how to configure the DRX.

### 2. New Radio (NR) V2X

On the basis of the LTE V2X, NR V2X is not limited to broadcast scenarios, but further expands to unicast and multicast scenarios, and the application of V2X is studied in these scenarios.

Similar to the LTE V2X, the NR V2X also defines two resource grant modes, mode-1/2 (i.e., the first mode and the second mode described above). Furthermore, the user may be in a mixed mode, that is, the mode-1 can be used to acquire resources, and the mode-2 can be used to acquire resources at the same time. Different from LTE V2X, in addition to feedback-free, UE-initiated Hybrid Automatic Repeat reQuest (HARQ) retransmission, feedback-based HARQ retransmission is introduced into the NR V2X, which is not limited to unicast communication, but also includes multicast communication.

### 3. Sidelink L2 U2N Relay Technology

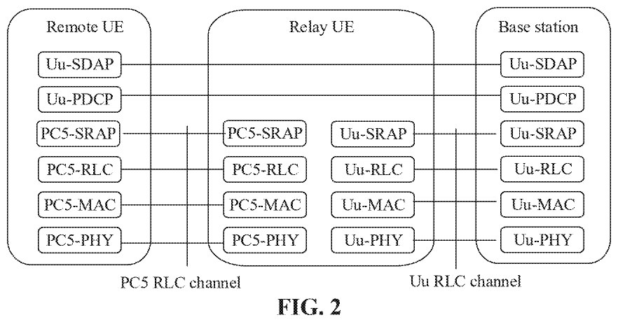

The user plane protocol stack for the sidelink L2 U2N relay architecture is shown in FIG. 2. For the L2 U2N relay, a Sidelink Relay Adaptation Protocol (SRAP) sublayer is located above the Radio Link Control (RLC) sublayer of the control plane and the user plane at the PC5 interface and the Uu interface. The Service Data Adaptation Protocol (SDAP), PDCP, and Radio Resource Control (RRC) sublayers of the Uu interface terminate between the remote UE and the base station (gNB) for the U2N relay, while the SRAP, RLC, MAC, and Physical Layer (PHY) sublayers terminate at each link (i.e., the link between the U2N relay UE and the remote UE for the U2N relay, and the link between the U2N relay UE and the gNB).

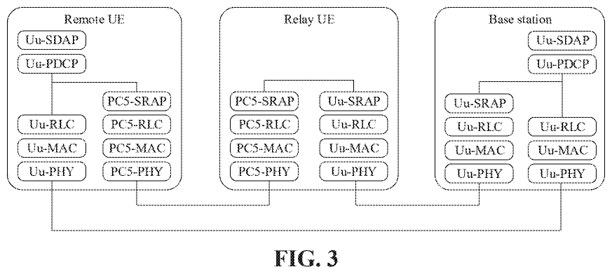

The user plane protocol stack for L2 Multi-path (MP) relay based on sidelink is shown in FIG. 3.

### 4. PDCP Duplication Transmission Mechanism

For the Signalling Radio Bearer (SRB), the status of duplication transmission is always active. For the Data Radio Bearer (DRB), the active state may be configured by the network through a RRC signalling and then turned on or off through a Media Access Control (MAC) Control Element (MAC CE). When the RRC configuration signalling is used, the value of the PDCP-Duplication IE in the PDCP configuration information PDCP-Config may be set to be ‘true’ or ‘false’, indicating whether or not duplication transmission for the DRB is configured, respectively. For the Radio Bearer (RB) for which the duplication transmission is configured through the RRC, the network further turns on/off the duplication transmission of the data packet of the bearer by transmitting a MAC CE for duplication activation/deactivation. The value of the i-th bit (0/1) indicates that the terminal needs to deactivate/activate the i-th DRB (the corresponding DRB ID is the ID of the i-th DRB among a plurality of DRBs which are configured with the PDCP-duplication IE corresponding to the cell group and arranged in ascending order). When the duplication transmission of the PDCP packet is not activated or is deactivated (through a MAC CE or a RRC signalling), the primary RLC entity and logical channel will still undertake the packet transmission work, while the secondary RLC entity and logical channel will not be used for the duplication transmission of the packet.

The related technologies/terms related to the embodiments of the present application have been briefly described above, and the following embodiments will not be repeatedly described.

It should be understood that the terms “system” and “network” are often used interchangeably herein. Herein, the term “and/or” is only an association relationship describing associated objects, and means that there may be three relationships. For example, A and/or B, may mean that A alone exists, both A and B exist, or B alone exists. In addition, the character “/” in this article generally indicates that the associated objects before “/” and after “/” are in an “or” relationship. It should also be understood that the term “indication” mentioned in the embodiments of the present application may be a direct indication, an indirect indication, or an associated relationship. For example, A indicates B, which may mean that A directly indicates B, for example, B can be acquired through A, or which may also mean that A indicates B indirectly, for example A indicates C, and B can be acquired through C, or which can also mean that there is an association relationship between A and B. It should also be understood that the term “correspondence” mentioned in the embodiments of the present application may indicate that there is a direct correspondence or indirect correspondence between two items, or may indicate that there is an association relationship between the two items, or may indicate a relationship between indicating and being indicated, configuring and being configured, or the like. It should also be understood that the term “predefined” or “predefined rule” mentioned in the embodiments of the present application can be realized by storing corresponding codes, tables, or other ways that can be used to indicate relevant information in advance in devices (e.g., including terminal devices and network devices), and the present application does not limit specific implementations thereof.

It should also be understood that the embodiments of the present application do not limit the specific forms of a terminal device and a network device.

A terminal device (or terminal) in the embodiments of the present application may refer to an access terminal, a User Equipment (UE), a subscriber unit, a subscriber station, a mobile station, a mobile site, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an Internet of Things (IoT) device, a satellite handheld terminal, a Wireless Local Loop (WLL) station, a Personal Digital Assistant (PDA), a handheld device with wireless communication functionality, a computing device or other processing device connected to a wireless modem, an in-vehicle device, a wearable device, a terminal device in a 5G network, or a terminal device in a future evolution network, or the like.

A network device in the embodiments of the present application may be an Evolutionary Node B (eNB or eNodeB) in an LTE system, a Next Generation Radio Access Network (NG RAN) device, a base station (gNB) in an NR system, or a radio controller in a Cloud Radio Access Network (CRAN), or the network device may be a relay station, an access point, an in-vehicle device, a wearable device, a hub, a switch, a bridge, a router, or a network device in a future evolved Public Land Mobile Network (PLMN).

In the U2N relay scenario, one or multiple paths between a remote terminal and a network may be non-direct paths, which may effectively improve reliability and throughput of data transmission for terminals outside a network coverage. However, since there is no direct path between the remote terminal and the network, it is necessary to solve a problem of how to activate a PDCP duplication transmission mechanism in this scenario.

At present, the network can control the terminal to activate the PDCP duplication transmission mechanism by transmitting the MAC CE to the terminal. However, in the U2N (L2 U2N) relay scenario, the MAC entity exists on the path of each hop between the network and the relay, and on the path of each hop between the relay and the remote terminal, but there is no MAC entity between the network and the remote terminal, whereas the PDCP entity is between the network and the remote terminal. Therefore, in a U2N relay scenario (e.g., in a multi-path U2N relay scenario), if each path between the remote terminal and the network is non-direct, the activation of the PDCP duplication transmission mechanism in this scenario cannot be controlled through the existing MAC CE mechanism. That is, in the U2N relay scenario, it is not clear how to control the activation of the PDCP duplication transmission mechanism if each path between the remote terminal and the network is non-direct.

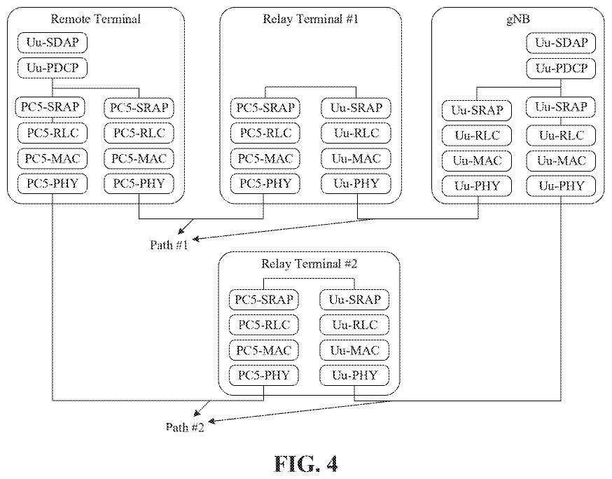

Taking a multipath U2N relay scenario as an example, FIG. 4 shows a schematic diagram of an example of a user plane protocol stack in this scenario. As shown in FIG. 4, there are two paths (links) between a remote terminal and a network (gNB), and there is a relay terminal on each path. For example, relay terminal #1 exists on path #1, and relay terminal #2 exists on path #2. In other words, both paths between the remote terminal and the network are non-direct paths. Since there is no MAC entity between the network and the remote terminal, but the PDCP entity is between the network and the remote terminal, the activation of the PDCP duplication transmission mechanism in this scenario cannot be controlled through the existing MAC CE mechanism in this scenario.

It should be noted that the number of paths between the remote terminal and the network in FIG. 4 is merely an example. For example, in some other scenarios, there may be one path between the remote terminal and the network, or there may be three or more paths, which are not limited by the embodiments of the present application.

It should also be noted that the number of relay terminals on each path in FIG. 4 is merely an example. For example, in some other scenarios, the number of relay terminals per path may be greater than 1.

In view of this, the present application provides a duplication transmission method and apparatus, a device, a chip, and a storage medium. In the method, there is one or multiple paths between a first device and a second device, and there are one or more relay terminal devices on each path. The first device may acquire first information, and thereby may determine whether to activate a PDCP duplication transmission mechanism of the first device based on the first information. The PDCP duplication transmission mechanism may be used for the first device to transmit first data to the second device. In this way, the activation control of the PDCP duplication transmission mechanism of the first device can be realized in a case that each path between the first device and the second device is a non-direct path.

Exemplarily, the first device in the embodiments of the present application may be a terminal device (such as a remote terminal device), and the second device may be a network device (such as a base station). In this case, the method may be applicable to a U2N relay scenario. Alternatively, both the first device and the second device may be a terminal device (such as a remote terminal device), in such case, the method may be applicable to a U2U relay scenario.

In order to facilitate understanding of the technical solutions of the embodiments of the present application, the technical solutions of the present application will be described in detail below with reference to specific embodiments. The above related technologies as an optional solution can be arbitrarily combined with the technical solutions of the embodiments of the present application, and all of them belong to the scope of the embodiments of the present application. The embodiments of the present application include at least some of the following contents.

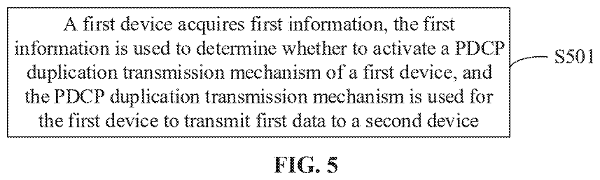

FIG. 5 is a schematic flowchart of a duplication transmission method according to an embodiment of the present application. In the method, there may be one or multiple paths (links) between a first device and a second device, and there may be one or more relay terminal devices on each link. As shown in FIG. 5, the method may include the following operation S501.

In S501, the first device acquires first information, the first information is used to determine whether to activate a PDCP duplication transmission mechanism of the first device, and the PDCP duplication transmission mechanism is used for the first device to transmit first data to the second device.

Here, the operation of activating the PDCP duplication transmission mechanism (for example, activating the PDCP duplication transmission mechanism of the first device) can also be understood as turning on the PDCP duplication transmission mechanism. In some scenarios, the PDCP duplication transmission mechanism may also be replaced by a PDCP duplication transmission, duplication transmission, or duplication transmission mechanism.

In the present embodiment, the first device may acquire the first information, and thus may determine whether to activate the PDCP duplication transmission mechanism of the first device based on the first information, and the PDCP duplication transmission mechanism may be used for the first device to transmit the first data to the second device.

In some embodiments, the first information may be from an upper layer of the first device, and the first information may be used to indicate whether to activate the PDCP duplication transmission mechanism. Alternatively, when the first data is of a specific service type, the first information may be used to indicate activating the PDCP duplication transmission mechanism. That is, the first device may determine whether to activate the PDCP duplication transmission mechanism according to an upper layer indication.

In an example, the first information is used to indicate whether to activate the PDCP duplication transmission mechanism. That is, the upper layer may explicitly indicate whether to activate the PDCP duplication transmission mechanism. For example, when the first information indicates that the PDCP duplication transmission mechanism is activated, the first device may activate the PDCP duplication transmission mechanism.

In another example, the first information is used to indicate that the PDCP duplication transmission mechanism is activated when the first data is of a specific service type (such as a high reliability low latency type, a voice data type, a non-voice data type, etc.). For example, when the first information indicates that the PDCP duplication transmission mechanism is activated when the first data is voice data, if the first data to be transmitted by the first device is voice data, the first device may activate the PDCP duplication transmission mechanism and transmit the first data to the second device based on the PDCP duplication transmission mechanism.

In some embodiments, the first information may include a Packet Error Rate (PER), when the PER is less than or equal to a first threshold, the PDCP duplication transmission mechanism is activated.

Exemplarily, when the first data is a DRB (denoted as a first DRB), the PER may be a minimum value, a maximum value, or an average value of PERs in Quality of Service (QoS) flows associated with the first DRB. For example, the first DRB may, for example, be associated with one or more QoS flows, then the PER may be a minimum value, a maximum value, or an average value of PERs in the one or more QoS flows.

It can be understood that when the PER is less than or equal to the first threshold, it may indicate that the requirement for the reliability of data transmission is high, and therefore, the first device may activate the PDCP duplication transmission mechanism to improve the reliability of transmitting the first data to the second device.

In some embodiments, the first threshold may be configured, for example, by a network.

In some embodiments, the first threshold is associated with one or more of the following information a) to e):

### a) a First QoS Parameter.

As an example, the first QoS parameter may include: for example, a priority of the first data; and/or a Packet Delay Budget (PDB). Taking the first QoS parameter including the priority of the first data as an example, the higher the priority of the first data, the higher the requirement for transmission reliability of the first data. Therefore, the first threshold may be relatively large, so that the condition that the PER is less than or equal to the first threshold is more easily met. That is, the condition for activating the PDCP duplication transmission mechanism is more easily met, and the reliability of transmitting the first data by the first device to the second device is improved.

### b) a First Measured Value.

As an example, the first measured value may include: for example, a level of congestion of a resource pool, and/or a signal quality.

Taking the first measured value including the level of congestion of the resource pool as an example, it can be understood that when the level of congestion of the resource pool is high, the duplication transmission of data should be restricted to control the entire data traffic. Therefore, the higher the level of congestion of the resource pool, the first threshold may be relatively low, so that the condition for activating the PDCP duplication transmission mechanism is more difficult to achieve.

Taking the first measured value including the signal quality as an example, it can be understood that the worse the signal quality is, the more unstable the path is. Therefore, in the case of poor signal quality, the first threshold may be relatively high, so that the condition for activating the PDCP duplication transmission mechanism can be more easily met, and the reliability of transmitting the first data by the first device to the second device can be improved.

### c) a Number of Relay Terminal Devices.

In some embodiments, the larger the number of relay terminal devices, the higher the probability of failure of data transmission, so in this case, the first threshold may be relatively high, so that the condition for activating the PDCP duplication transmission mechanism can be more easily achieved, thereby improve the success rate of data transmission.

In some embodiments, when the number of relay terminal devices is larger, it indicates that the more resources are occupied. Therefore, in this case, the duplication transmission of data should be restricted, so the first threshold may be relatively low, so that the conditions for activating the PDCP duplication transmission mechanism are more difficult to achieve.

d) a Manner in which the First Device (the First Device is a Terminal Device) Acquires Transmission Resources.

In some embodiments, if the manner in which the first device acquires the transmission resource is mode1, that is, the transmission resource of the first device is allocated by the base station, in this case, it may be considered that the probability of resource collision of the transmission resources is low, and the reliability of data transmission is relatively high, so it is not necessary to activate the PDCP duplication transmission mechanism. Therefore, the first threshold may be relatively low, so that the conditions for activating the PDCP duplication transmission mechanism are more difficult to achieve.

In some embodiments, if the manner in which the first device acquires the transmission resource is mode2, that is, the first device selects a resource from a resource pool to transmit data, in this case, it may be considered that the probability of resource collision of the transmission resources is high, and the reliability of data transmission is relatively low, so it is necessary to activate the PDCP duplication transmission mechanism. Therefore, the first threshold may be relatively high, so that the conditions for activating the PDCP duplication transmission mechanism can be more easily achieved.

### e) a RLC Mode.

For example, in a case that the RLC mode is an Acknowledge Mode (AM), since the AM supports feedback, which is beneficial to ensure the reliability of data transmission, it may not be necessary to activate the PDCP duplication transmission mechanism. Therefore, the first threshold may be relatively low, so that the conditions for activating the PDCP duplication transmission mechanism are more difficult to achieve.

According to the above technical solutions, the first device can determine whether or not to activate the PDCP duplication transmission mechanism by comparing the PER and the first threshold, and the first threshold can be related to one or more of the information in the above a) to e), so that the first device can determine whether or not to activate the PDCP duplication transmission mechanism by considering various factors such as the PER, so as to meet the corresponding data transmission requirements.

In some embodiments, when there are multiple paths between the first device and the second device, the first information may include: a data transmission result received by the first device on a first path of the multiple paths within a first time period. The data transmission result may from a first relay terminal device on the first path, and the first relay terminal device is directly connected to the first device. That is, the first relay terminal device on the first path may transmit a data transmission result (first information) within a first time period to the first device. Accordingly, the first device may receive the data transmission result, thereby determining whether to activate the PDCP duplication transmission mechanism based on the transmission result.

In the embodiments of the present application, the first relay terminal device is directly connected to the first device, which may also be understood as that the number of hops from the first device to the first relay terminal device is per-hop.

Exemplarily, the first path may be, for example, any path between the first device and the second device, or may be a specific path between the first device and the second device. The particular path may be configured by the network, for example, or a primary path (primary link).

In some embodiments, the PDCP duplication transmission mechanism is activated when a first condition is met, and the first condition may include that: the data transmission result (i.e., a data transmission result within the first time period described above) includes a first number of consecutive non-positive feedbacks; or, the data transmission result includes a first number of non-positive feedbacks.

In an example, the first condition may include that: the data transmission result include the first number (e.g., N) of consecutive non-positive feedbacks. That is, if the first device continuously receives at least a first number (e.g., at least N) of non-positive feedbacks (e.g., Negative Acknowledgment (NACK), or no Acknowledgment (ACK) is received) from the first relay terminal device on the first path within a first time period, the PDCP duplication transmission mechanism may be activated.

In another example, the first condition may include that: the data transmission result includes the first number (e.g., N) of non-positive feedbacks. That is, if the first device receives at least a first number (e.g., at least N) of non-positive feedbacks (e.g., NACK, or ACK is not received) from the first relay terminal device on the first path within a first time period, the PDCP duplication transmission mechanism may be activated.

In some embodiments, when there is a path between the first device and the second device, the first information may include: a data transmission result received by the first device over the path within a first time period. The data transmission result may from a first relay terminal device on the path, and the first relay terminal device is directly connected to the first device. That is, the first relay terminal device on the path may transmit a data transmission result (first information) within a first time period to the first device, and accordingly, the first device may receive the data transmission result, thereby determining whether to activate the PDCP duplication transmission mechanism based on the transmission result.

In some embodiments, the PDCP duplication transmission mechanism is activated in a case that a first condition is met. The first condition may include that: the data transmission result (i.e., the data transmission result within the first time period described above) includes a first number of consecutive non-positive feedbacks; or, the data transmission result includes a first number of non-positive feedbacks.

In an example, the first condition may include that the data transmission result includes a first number (e.g., N) of consecutive non-positive feedbacks. That is, if the first device continuously receives at least a first number (e.g., at least N) of non-positive feedbacks (e.g., NACK, or no ACK is received) from the first relay terminal device on the path within the first time period, the PDCP duplication transmission mechanism may be activated.

In another example, the first condition may include that the data transmission result includes a first number (e.g., N) of non-positive feedbacks. That is, if the first device receives at least a first number (e.g., at least N) of non-positive feedbacks (e.g., NACK, or no ACK is received) from the first relay terminal device on the path within the first time period, the PDCP duplication transmission mechanism may be activated.

In some embodiments, when there are multiple paths between the first device and the second device, the first information may include: data transmission results respectively received by the first device over at least two of the multiple paths within a first time period. A data transmission result received by the first device on each of the at least two paths is from a first relay terminal device on the path, the first relay terminal device is directly connected to the first device.

For example, it is assumed that there are two paths between the first device and the second device, namely path #1 and path #2, respectively, the first information may include a data transmission result received by the first device over the path #1 within a first time period, and a data transmission result received by the first device over the path #2 within the first time period. The data transmission result received by the first device over the path #1 is from the first relay terminal device on the path #1. The data transmission result received by the first device over the path #2 is from the first relay terminal device on the path #2.

In some embodiments, the PDCP duplication transmission mechanism is activated in a case that a second condition is satisfied, the second condition may include that: each of the data transmission results includes a first number of consecutive non-positive feedbacks; or each of the data transmission results includes a first number of non-positive feedbacks; or, a sum of the number of consecutive non-positive feedbacks included in each of the data transmission results reaches a first number; or, a sum of the number of non-positive feedbacks included in each of the data transmission results reaches a first number.

In one example, the first condition may include that each of the data transmission results includes a first number (e.g., N) of consecutive non-positive feedbacks.

For example, it is assumed that there are two paths between the first device and the second device, namely path #1 and path #2, respectively, if the first device continuously receives at least a first number (e.g., at least N) of non-positive feedbacks from the first relay terminal device of path #1 and also continuously receives at least the first number (e.g., at least N) of non-positive feedbacks from the first relay terminal device of path #2 within the first time period, the PDCP duplication transmission mechanism may be activated.

In another example, the first condition may include that each of the data transmission results includes a first number of non-positive feedbacks.

For example, it is assumed that there are two paths between the first device and the second device, namely path #1 and path #2, respectively, if the first device receives at least a first number (e.g., at least N) of non-positive feedbacks from the first relay terminal device of path #1 and also receives at least the first number (e.g., at least N) of non-positive feedbacks from the first relay terminal device of path #2 within the first time period, the PDCP duplication transmission mechanism may be activated.

In another example, the first condition may include that the sum of the number of consecutive non-positive feedbacks included in each of the data transmission results reaches the first number.

For example, it is assumed that there are two paths between the first device and the second device, namely path #1 and path #2, respectively, and it is assumed that within a first time period, the number of non-positive feedbacks continuously received by the first device from the first relay terminal device of the path #1 is n₁, and the number of non-positive feedbacks continuously received by the first device from the first relay terminal device of the path #2 is n₂, then if the result of n₁+n₂ is greater than or equal to the first number, the PDCP duplication transmission mechanism may be activated.

In another example, the first condition may include that the sum of the number of non-positive feedbacks included in each of the data transmission results reaches the first number.

For example, it is assumed that there are two paths between the first device and the second device, namely path #1 and path #2, respectively, and it is assumed that within the first time period, the number of non-positive feedbacks received by the first device from the first relay terminal device of the path #1 is n₃, and the number of non-positive feedbacks received by the first device from the first relay terminal device of the path #2 is n₄, then if the result of n₃+n₄ is greater than or equal to the first number, the PDCP duplication transmission mechanism may be activated.

According to the above technical solution, the first device may determine whether to activate the PDCP duplication transmission mechanism according to the data transmission result from the first relay terminal device. Since the larger the number of non-positive feedbacks in the data transmission result, the worse the channel quality and the lower the probability of successful data transmission, the first device may activate the PDCP duplication transmission mechanism when the number of non-positive feedbacks is larger, so as to improve the probability of successful transmission of the first data by the first device to the second device.

In some embodiments, the above-described first number may be configured, for example, by a network.

In some embodiments, the first number relates to one or more of the following information: a PER (which may be included in a QoS parameter); a first QoS parameter; a first measured value; a number of relay terminal devices; a manner in which the first device acquires transmission resources; or, a RLC mode.

In some embodiments, when the first data is a DRB (denoted as the first DRB), the PER may be a minimum value, a maximum value, or an average value of PERs in QoS flows associated with the first DRB is. The first QoS parameter may include, for example: a priority of the first data; and/or, a PDB. The first measured value may include, for example, a level of congestion of a resource pool, and/or a signal quality.

As an example, the first number may be related to the PER. It can be understood that the smaller the PER in the QoS parameter, the higher the reliability requirement for data transmission. Therefore, in a case that the PER is small, the first number may be relatively small, so that the conditions for activating the PDCP duplication transmission mechanism are more easily achieved, thereby improving the reliability of transmitting the first data by the first device to the second device.

As another example, the first number may be related to the priority of the first data. It can be understood that since the higher the priority of the first data, the higher the reliability requirement for the transmission of the first data. Therefore, in a case that the priority of the first data is high, the first number may be relatively small, so that the condition for activating the PDCP duplication transmission mechanism can be more easily achieved, thereby improving the reliability of transmitting the first data by the first device to the second device.

The relationship between the first number and other related information can be inferred based on the description of the information a) to e) in the foregoing embodiments, and will not be repeated here.

In some embodiments, the above-described first time period may be configured, for example, by a network.

In some embodiments, the first time period is related to one or more of the following information: a PER (which may be included in a QoS parameter, for example, may be a minimum value, a maximum value, or an average value of PERs in QoS flows associated with the first DRB); a first QoS parameter (e.g., may include a priority and/or a PDB of the first data); a first measured value (which may include, for example, a level of congestion of a resource pool and/or a signal quality); a number of relay terminal devices; a manner in which the first device acquires transmission resources; or, a RLC mode.

As an example, the first time period may be related to the PER. It can be understood that the smaller the PER in the QoS parameter, the higher the reliability requirement for data transmission. Therefore, in a case that the PER is small, the first time period may be relatively large, so that the conditions for activating the PDCP duplication transmission mechanism are more easily achieved, thereby improving the reliability of transmitting the first data by the first device to the second device.

As another example, the first time period may be related to the priority of the first data. It can be understood that since the higher the priority of the first data, the higher the reliability requirement for transmission of the first data. Therefore, in a case that the priority of the first data is higher, the first time period may be relatively longer, so that the condition for activating the PDCP duplication transmission mechanism can be more easily achieved, thereby improving the reliability of transmitting the first data by the first device to the second device.

The relationship between the first time period and other related information can be inferred based on the description of the information a) to e) in the foregoing embodiments, and will not be repeatedly described here.

In some embodiments, the first time period may be, for example, a value of a timer (a timing duration of the timer), the timer may start timing, for example, when the first device receives non-positive feedback.

According to the above-described technical solution, the first device can determine whether to activate the PDCP duplication transmission mechanism in the case of integrating a plurality of factors such as data transmission results to meet the corresponding data transmission requirements.

In some embodiments, the data transmission result described above may be, for example, a HARQ feedback result or an RLC feedback result.

In some embodiments, the first information may include a data transmission result from the second device, the data transmission result is used to determine an amount of lost data in data transmitted by the first device to the second device. That is, the second device may transmit first information to the first device, the first information includes the data transmission result. Therefore, the first device may determine the amount of lost data among the data transmitted by the first device to the second device according to the data transmission result from the second device, and further determine whether to activate the PDCP duplication transmission mechanism based on the amount of lost data.

Exemplarily, the data transmission result from the second device may be, for example, a PDCP Status Report (SR).

In some embodiments, the PDCP duplication transmission mechanism is activated when the amount of lost data is greater than or equal to a second threshold.

It can be understood that the greater the amount of lost data, the worse the channel quality, and the lower the probability of successful data transmission. Therefore, when the amount of lost data is greater (for example, when the amount of lost data is greater than or equal to the second threshold), the first device may activate the PDCP duplication transmission mechanism to improve the probability of successful transmission of the first data from the first device to the second device.

In some embodiments, the second threshold may be configured, for example, by the network.

In some embodiments, the second threshold is related to one or more of the following information: a PER (which may be included in a QoS parameter); a first QoS parameter; a first measured value; a number of relay terminal devices; a manner in which the first device acquires transmission resources; or, a RLC mode.

In some embodiments, when the first data is a DRB (denoted as the first DRB), the PER may be a minimum value, a maximum value, or an average value of PERs in QoS flows associated with the first DRB. The first QoS parameter may include, for example: a priority of the first data, and/or, a PDB. The first measured value may include, for example, a level of congestion of a resource pool, and/or a signal quality.

In one example, the second threshold may be related to the PER. It can be understood that the smaller the PER in the QoS parameter, the higher the reliability requirement for data transmission. Therefore, in a case that the PER is small, the second threshold may be relatively small to make it easier to achieve the condition for activating the PDCP duplication transmission mechanism, thereby improving the reliability of transmitting the first data by the first device to the second device.

As another example, the second threshold may be related to the priority of the first data. It can be understood that since the higher the priority of the first data, the higher the reliability requirement for transmission of the first data. Therefore, in a case that the priority of the first data is high, the second threshold may be relatively small, so that the condition for activating the PDCP duplication transmission mechanism can be more easily achieved, thereby improving the reliability of transmitting the first data by the first device to the second device.

The relationship between the second threshold and other related information can be inferred based on the description of the information a) to e) in the foregoing embodiments, and will not be repeatedly described here.

According to the above-described technical solution, the first device can determine whether to activate the PDCP duplication transmission mechanism in consideration of various factors such as the amount of lost data, so as to meet the corresponding requirements for data transmission.

In some embodiments, the first information may include a data amount (or an amount of data included) included in one or more of the PDCP layer, the RLC layer, and the MAC layer of the first device.

In an example, the first information may include an amount of data included in one of a PDCP layer, an RLC layer, and a MAC layer of the first device. For example, the first information may include an amount of data included in the PDCP layer of the first device. Here, the amount of data contained in the PDCP layer can also be understood as an amount of data contained in a buffer of the PDCP layer.

As another example, the first information may include an amount of data (a total data amount) included in multiple layers of the PDCP layer, the RLC layer, and the MAC layer of the first device. For example, the first information may include an amount of data (total amount of data) included in the PDCP layer, the RLC layer, and the MAC layer of the first device. The amount of data contained in the RLC layer can also be understood as an amount of data contained in a buffer of the RLC layer. The amount of data contained in the MAC layer can also be understood as an amount of data contained in a buffer of the MAC layer.

For example, it is assumed that the amount of data included in the PDCP layer of the first device is m₁, the amount of data included in the RLC layer is m₂, and the amount of data included in the MAC layer is m₃, then the amount of data (total amount of data) included in the PDCP layer, the RLC layer, and the MAC layer of the first device is m₁+m₂+m₃.

In some embodiments, when the data amount is less than or equal to a third threshold, the PDCP duplication transmission mechanism is activated.

It can be understood that since the larger the amount of data, the more data to be transmitted by the first device, there may be a situation where transmission resources are insufficient. Therefore, when the amount of data is large, the PDCP duplication transmission mechanism should not be activated, and when the amount of data is small (for example, when the amount of data is less than or equal to the third threshold), the first device may activate the PDCP duplication transmission mechanism to improve the reliability of transmitting the first data by the first device to the second device.

In some embodiments, the third threshold may be configured, for example, by the network.

In some embodiments, the third threshold is related to one or more of the following information: a PER (which may be included in a QoS parameter); a first QoS parameter; a first measured value; a number of relay terminal devices; a manner in which the first device acquires transmission resources; or, a RLC mode.

In some embodiments, when the first data is a DRB (denoted as a first DRB), the PER may be a minimum value, a maximum value, or an average value of PERs in the QoS flows associated with the first DRB. The first QoS parameter may include: for example, a priority of the first data; and/or, a PDB. The first measured value may include: for example, a level of congestion of a resource pool; and/or a signal quality.

As an example, the third threshold may be related to the PER. It can be understood that the smaller the PER in the QoS parameter, the higher the reliability requirement for data transmission. Therefore, in a case that the PER is small, the third threshold may be relatively large, so that the conditions for activating the PDCP duplication transmission mechanism is more easily achieved, thereby improving the reliability of transmitting the first data by the first device to the second device.

As another example, the third threshold may be related to a priority of the first data. It can be understood that since the higher the priority of the first data, the higher the reliability requirement of transmission of the first data. Therefore, in a case that the priority of the first data is high, the third threshold may be relatively large, so that the condition for activating the PDCP duplication transmission mechanism is more easily achieved, thereby improving the reliability of transmitting the first data by the first device to the second device.

The relationship between the third threshold and other related information can be inferred based on the description of the information a) to e) in the foregoing embodiments, and will not be described herein.

According to the above-described technical solution, the first device can determine whether to activate the PDCP duplication transmission mechanism in consideration of various factors such as the data amount of data to be transmitted, so as to meet the corresponding data transmission requirements.

In some embodiments, if there are multiple paths between the first device and the second device, then when the PDCP duplication transmission mechanism is activated, at least two of the multiple paths may be used for the first device to transmit the first data to the second device, or the at least two paths may be activated. The at least two paths may, for example, be determined by the first device.

For example, it is assumed that there are three paths between the first device and the second device, namely path #1, path #2, and path #3, respectively, the first device may select at least two of the paths for transmission of the first data when the PDCP duplication transmission mechanism is activated. For example, the first device may select the path #1 and the path #3 for transmitting the first data, that is, the first device may simultaneously transmit the first data to the second device through the path #1 and the path #3, so as to improve the reliability of transmitting the first data by the first device to the second device.

In some embodiments, if there is one path between the first device and the second device, the first device may transmit multiple (e.g., two) copies of the first data to the second device over the path based on a Carrier Aggregation (CA) technique to improve the reliability of transmitting the first data by the first device to the second device.

In some embodiments, the first information may be a control signalling from the second device, such as a PDCP Control Protocol Data Unit (PDU).

That is, the second device may transmit a control signalling (first information) to the first device. Accordingly, the first device may receive the control signalling, thereby determining whether to activate the PDCP duplication transmission mechanism based on the control signalling.

In some embodiments, the control signalling may be used to indicate whether to activate the PDCP duplication transmission mechanism.

As one implementation, the control signalling may include an activation/deactivation indication (denoted DA) for indicating whether to activate the PDCP duplication transmission mechanism. In an example, when the activation/deactivation indication is set to 0, it indicates that the PDCP duplication transmission mechanism is deactivated; when the activation/deactivation indication is set to 1, it indicates that the PDCP duplication transmission mechanism is activated. As another example, when the activation/deactivation indication is set to 1, it indicates that the PDCP duplication transmission mechanism is deactivated; when the activation/deactivation indication is set to 0, it indicates that the PDCP duplication transmission mechanism is activated.

In some embodiments, when the DA indicates that the PDCP duplication transmission mechanism is activated, if there are multiple paths between the first device and the second device, the multiple paths may all be activated for the first device to transmit the first data to the second device. That is, the first device may simultaneously transmit the first data to the second device on the multiple paths, to improve the reliability of transmitting the first data by the first device to the second device.

In some embodiments, when that DA indicates that the PDCP duplication transmission mechanism is activated, if there is one path between the first device and the second device, the first device may transmit multiple copies (e.g., two copies) of the first data to the second device on the path based on the CA technique to improve the reliability of transmitting the first data by the first device to the second device.

In some embodiments, when there are multiple paths between the first device and the second device, the control signalling may be used to indicate that the PDCP duplication transmission mechanism is activated, and indicate at least two paths of the multiple paths for the first device to transmit the first data to the second device.

That is, based on the control signalling, the first device may know whether to activate the PDCP duplication transmission mechanism, and may know at least two paths for transmitting the first data to the second device.

As one implementation, the control signalling may include an activation/deactivation indication (DA), and a configuration corresponding to each path between the first device and the second device. Herein, DA may be used to indicate whether to activate the PDCP duplication transmission mechanism. In the case that the DA indicates that the PDCP duplication transmission mechanism is activated, the configuration corresponding to each path may be used to indicate the activated path. For example, in a case that the DA indicates that the PDCP duplication transmission mechanism is activated, if the configuration corresponding to two or more paths is set to activate (e.g., set to 1), the two or more paths may be used for the first device to transmit the first data to the second device.

As another implementation, the control signalling may include a configuration corresponding to each path between the first device and the second device. Wherein the configuration corresponding to each path may be used to indicate whether the path is activated for the first device to transmit the first data to the second device. For example, if the configuration corresponding to two or more paths is set to active (e.g., set to 1), it indicates that the PDCP duplication transmission mechanism needs to be activated, and the two or more paths need to be activated, so that the first device can transmit the first data to the second device on the two or more paths.

In some embodiments, the first information is a control signalling from at least one first relay terminal device. The at least one first relay terminal device is located on at least one path between the first device and the second device, respectively, and the at least one first relay terminal device is directly connected to the first device.

For example, it is assumed that there are two paths between the first device and the second device, namely path #1 and path #2, respectively, the at least one first relay terminal device may be a relay terminal device directly connected to the first device on the path #1 or the path #2, or the at least one first relay terminal device may include a relay terminal device directly connected to the first device on the path #1 and a relay terminal device directly connected to the first device on the path #2.

That is, a first relay terminal device (s) on one or multiple paths between the first device and the second device may transmit the control signalling (first information) to the first device. Accordingly, the first device may receive the control signalling, thereby determining whether to activate the PDCP duplication transmission mechanism based on the control signalling.

Exemplarily, the control signalling from the at least one first relay terminal device may be, for example, a MAC CE, an RLC control PDU, or an SRAP control PDU.

In some embodiments, the first data includes one or more DRBs, and the first information may be used to indicate that the PDCP duplication transmission mechanism is activated or deactivated, and indicate the one or more DRBs.

That is, based on the control signalling, the first device may know whether to activate the PDCP duplicate transmission mechanism, and may know one or more DRBs to be transmitted based on the PDCP duplicate transmission mechanism.

In some embodiments, when the control signalling is a MAC CE, the MAC CE may include: for example, configurations corresponding to a plurality of DRBs. the configuration corresponding to each DRB may be used to indicate whether the DRB needs to be transmitted based on the PDCP duplication transmission mechanism. For example, if the configurations corresponding to one or more of the plurality of DRBs are set to active (e.g., set to 1), they indicate that the first device should activate the PDCP duplication transmission mechanism for transmitting the one or more DRBs, which are set to active, to the second device. In other words, if the configurations corresponding to one or more DRBs of the plurality of DRBs are set to activate (for example, set to 1), the first device needs to transmit the one or more DRBs, which are set to activate, to the second device based on the PDCP duplication transmission mechanism.

In some embodiments, when the control signalling is an RLC control PDU or an SRAP control PDU, the RLC control PDU or the SRAP control PDU may include, for example, an activation/deactivation indication (denoted DA) and configurations corresponding to a plurality of DRB. Herein, the DA may be used to indicate whether to activate the PDCP duplication transmission mechanism. In an example, when the activation/deactivation indication is set to 0, it indicates that the PDCP duplication transmission mechanism is deactivated; when the activation/deactivation indication is set to 1, it indicates that the PDCP duplication transmission mechanism is activated. In another example, when the activation/deactivation indication is set to 1, it indicates that the PDCP duplication transmission mechanism is deactivated; when the activation/deactivation indication is set to 0, it indicates that the PDCP duplication transmission mechanism is activated.

When the DA indicates that the PDCP duplication transmission mechanism is activated, the configurations corresponding to the plurality of DRBs may be used to indicate one or more DRBs to be transmitted based on the PDCP duplication transmission mechanism. For example, in a case that the DA indicates that the PDCP duplication transmission mechanism is activated, if the configurations corresponding to one or more of the plurality of DRBs are set to active (e.g., set to 1), it indicates that the first device should activate the PDCP duplication transmission mechanism for transmitting the one or more DRBs, which are set to active, to the second device. In other words, when the DA indicates that the PDCP duplication transmission mechanism is activated, if the configurations corresponding to one or more of the plurality of DRBs is set to active (for example, set to 1), the first device needs to transmit the one or more DRBs, which are set to active, to the second device based on the PDCP duplication transmission mechanism.

In some embodiments, the first information may be determined based on the second information from the second device, or the first information may be triggered and controlled based on the second information from the second device. The second information may be used to indicate, an identifier (ID) of the first device; activating or deactivating the PDCP duplication transmission mechanism; and one or more DRBs to be transmitted based on the PDCP duplication transmission mechanism.

That is, the second device may transmit the second information to the at least one first relay terminal device. Accordingly, the at least one first relay terminal device may receive the second information from the second device. After receiving the second information, the at least one first relay terminal device may determine that the device that needs to activate the PDCP duplication transmission mechanism is the first device based on the identifier of the first device carried in the second information, and may determine/set the first information to be transmitted to the first device according to the content indicated in the second information.

For example, if the second information includes configurations corresponding to a plurality of DRBs, the first relay terminal device may carry the configurations corresponding to the plurality of DRBs in the first information and transmit it to the first device. For another example, if the second information includes an activation/deactivation indication and configurations corresponding to a plurality of DRBs, the first relay terminal device may carry the activation/deactivation indication and the configurations corresponding to a plurality of DRBs in the first information and transmit it to the first device.

In some embodiments, the first device is a terminal device, and the second device is a network device or a terminal device.

For example, if the first device is a terminal device (such as a remote terminal device) and the second device is a network device, in this case, the method of the embodiments of the present application may be applied to a U2N relay scenario. In another example, the first device and the second device are both terminal devices (such as remote terminal devices), and in this case, the method of the embodiments of the present application may be applied to a U2U relay scenario.

The duplication transmission method provided by the embodiments of the present application has been described above, and in order to facilitate understanding of the embodiments of the present application, possible schemes applicable to the duplication transmission method of the embodiments of the present application are described below by taking the first device being a remote terminal device (hereinafter referred to as a remote terminal) and the second device being a network device (hereinafter referred to as a network) as examples.

Exemplarily, the possible implementations include schemes 1-3.
Scheme 1: The remote terminal activates the PDCP duplication transmission mechanism according to a certain rule.
Scheme 2: The remote terminal activates/deactivates the PDCP duplication transmission mechanism according to an end-to-end (E2E) control signalling from the network.
Scheme 3: The remote terminal activates/deactivates the PDCP duplication transmission mechanism based on a per-hop control signalling from a relay terminal (an example of the first relay terminal device described above).

The above three schemes are introduced below.

### Scheme 1

In the first scheme, when the network configures the PDCP duplication transmission mechanism for the remote terminal, the remote terminal can activate the PDCP duplication transmission mechanism according to a certain rule.

In a first implementation, the remote terminal may determine whether to activate the PDCP duplication transmission mechanism according to an indication of an upper layer (such as a Non-Access Stratum (NAS) or Prose).

In one example, the upper layer may explicitly indicate whether to activate the PDCP duplication transmission mechanism. For example, when the upper layer indicates that the PDCP duplication transmission mechanism is activated, the terminal may activate the PDCP duplication transmission mechanism.

As another example, the upper layer may implicitly indicate whether to activate the PDCP duplication transmission mechanism. For example, the upper layer may indicate that the terminal may activate the PDCP duplication transmission mechanism when the data to be transmitted (for example, PDU data; for another example, QoS flow data) is data with a specific service type.

In a second implementation, the remote terminal may determine whether to activate the PDCP duplication transmission mechanism according to a QoS parameter (such as a PER). The following is described by using the QoS parameter being a PER as an example.

As an example, if PER<threshold #1, the PDCP duplication transmission mechanism is activated. Here, the threshold #1 may be configured by the network, and the value of the PER may be a minimum value, a maximum value, or an average value of PERs in the QoS flows associated with the DRB to be transmitted.

As another example, if PER<threshold #2, the PDCP duplication transmission mechanism is activated. Here, the threshold #2 is associated with a priority (or other a QoS parameter, such as a PDB) of data, that is, the thresholds #2 corresponding to different priorities are different. The threshold #2 may be configured by the network, and the value of the PER may be a minimum value, a maximum value, or an average value of PERs in QoS flows associated with the DRB to be transmitted.

As another example, if PER<threshold #3, the PDCP duplication transmission mechanism is activated. Here, the threshold #3 is associated with the level of congestion of the resource pool (or other measurement values, such as a signal quality), that is, the thresholds #3 corresponding to different levels of congestion of resource pools are different. The threshold #3 may be configured by the network, and the value of the PER may be a minimum value, a maximum value, or an average value of PERs in QoS flows associated with the DRB to be transmitted.

It should be noted that the threshold used for comparison with the PER may also be related to one or more other parameters. For example, if PER<threshold #4, the PDCP duplication transmission mechanism is activated, threshold #4 may be related to both a priority of data and a level of congestion of a resource pool and/or other variables (such as the number of relay hops, a resource acquisition mode, a RLC mode, etc.).

In the third implementation, the remote terminal may determine whether to activate the PDCP duplication transmission mechanism according to the data transmission result.

In some embodiments, the data transmission result may be, for example, a data transmission result for a single hop (between a remote terminal and a relay terminal), such as a HARQ feedback or a RLC feedback from the relay terminal.

As an example, if a remote terminal receives N non-positive feedbacks (NACK/or no ACK is received) consecutively, the PDCP duplication transmission mechanism is activated. The determination method for the remote terminal to determine whether N non-positive feedbacks have been continuously received can be realized by defining a timer and a counter, for example. For example, the remote terminal may turn on the timer when receiving a non-positive feedback, turn off the timer when receiving a positive feedback. The counter starts counting from 0 after the timer is turned on. The counter is set to zero when the timer times out or the counter is turned off. If the value of the counter reaches N, it means that the remote terminal has continuously received N non-positive feedbacks, and thus the remote terminal may activate the PDCP duplication transmission mechanism.

As another example, if the remote terminal receives M non-positive feedbacks (not consecutive) within a certain period of time, the PDCP duplication transmission mechanism is activated. The determination method for the remote terminal to determine whether M non-positive feedbacks have been received within a certain period of time may be realized, for example, by defining a timer and a counter. For example, the remote terminal may turn on the timer when receiving a non-positive feedback, the counter starts counting from 0 after the timer is turned on. The counter is set to zero when the timer times out. If the value of the counter reaches M, it means that the remote terminal has received M non-positive feedbacks, and thus the remote terminal may activate the PDCP duplication transmission mechanism.

In some embodiments, a value of the above-described timer (timing duration of the timer) and values of M and N may be configured by the network, and the values configured by the network (the value of the timer, M and N) may be related to one or more of the following information: a PER, a data priority, a PDB, a level of congestion of a resource pool, a signal quality, the number of relay hops, a resource acquisition mode, and a RLC mode.

It should be noted that, for the above counting, a counting of a single path, or mix counting of a plurality of paths may be considered.

In some embodiments, the counting of the single path may be considered. For example, if any path between the remote terminal and the network meets the condition (in an example, N non-positive feedbacks are continuously received on the path; in another example, M non-positive feedbacks are received within a certain period of time), the PDCP duplication transmission mechanism is activated. For another example, if a specific path between the remote terminal and the network meets the condition, the PDCP duplication transmission mechanism is activated. The specific path may be configured by the network, for example, or the specific path may be a primary path.

In some embodiments, the mix counting of a plurality of paths may be considered. As an example, the PDCP duplication transmission mechanism is activated if the number sum for the plurality of paths reaches a corresponding number. For example, it is assumed that the plurality of paths include a path #1 and a path #2, if the result of adding the number of non-positive feedbacks continuously received on the path #1 and the number of non-positive feedbacks continuously received on the path #2 reaches a corresponding number, the PDCP duplication transmission mechanism may be activated. As another example, if both paths reach a corresponding number, the PDCP duplication transmission mechanism is activated. For example, it is assumed that the plurality of paths include a path #1 and a path #2, if the number of non-positive feedbacks continuously received on the path #1 and the number of non-positive feedbacks continuously received on the path #2 both reach a certain number, the PDCP duplication transmission mechanism may be activated.

In some embodiments, the data transmission result may be, for example, a data transmission result of E2E (between a remote terminal and a network). That is, the remote terminal can determine whether to activate the PDCP duplication transmission mechanism according to the data transmission result between the remote terminal and the network. The data transmission result may be, for example, a PDCP SR from the network.

As an example, if the remote terminal finds that the amount of lost data is >threshold #5 according to the PDCP SR from the network, the remote terminal activates the PDCP duplication transmission mechanism. Herein, the threshold #5 may be configured by the network, for example. In some embodiments, the threshold #5 may be related to one or more of the following information: a PER, a priority of data, a PDB, a level of congestion of a resource pool, a signal quality, a number of relay hops, a resource acquisition manner, and RLC mode.

In a fourth implementation, the remote terminal may determine whether to activate the PDCP duplication transmission mechanism according to an amount of data in a buffer. Exemplarily, the amount of data in the buffer may include, for example, at least one of the following: an amount of data in a buffer of a PDCP layer; an amount of data in a buffer of a RLC layer; and an amount of data in a buffer of a MAC layer.

In some embodiments, the PDCP duplication transmission mechanism is activated if the amount of data in the buffer is <threshold #6. Herein, the threshold #6 may be configured by the network, for example. In some embodiments, the threshold #6 may be related to one or more of the following information: a PER, a priority of data, a PDB, a level of congestion of a resource pool, a signal quality, a number of relay hops, a resource acquisition manner, and a RLC mode.

### Scheme 2

In Scheme 2, the remote terminal may activate/deactivate the PDCP duplication transmission mechanism according to an E2E control signalling from the network.

In some embodiments, the control signalling is a PDCP control PDU. Exemplarily, the PDCP control PDU may include parameters in the following 1) to 4):
1) D/C bit: used to indicate whether it is data or a control PDU.
2) PDU type (3 bits). For example, 100 represents a duplication transmission (PDCP duplication transmission mechanism) activation/deactivation control PDU. PDU types are shown in Table 1.

TABLE 1

| Bit | Description |
|---|---|
| 000 | PDCP status report |
| 001 | Robust Header Compression (ROHC) feedback |
| | (Interspersed ROHC feedback) |
| 010 | Ethernet Header Compress (EHC) Feedback (EHC feedback) |
| 011 | Uplink Data Compression (UDC) feedback (UDC feedback) |
| 100 | Duplication Transmission Activation/Deactivation |
| 101-111 | Reserved |

3) Activation/deactivation indication (denoted by DA). For example, 0 indicates deactivation and 1 indicates activation.
4) Rᵢ: indicates the path number to be activated.

In some embodiments, Rᵢ and an activation/deactivation (inactivation) indication may be used together. For example, an activation/deactivation indication may be used to indicate whether duplication transmission is activated, and Rᵢ may be used to indicate which path is activated.

In some embodiments, Rᵢ may be used separately to indicate which path is activated.

In some embodiments, the activation/deactivation indication may be used separately. For example, in the case that DA indicates that the duplication transmission is activated, all paths are activated.

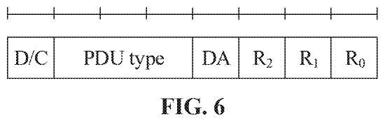

FIG. 6 is a schematic diagram illustrating an example of a format of a PDCP control PDU according to an embodiment of the present application. In FIG. 6, if it is necessary to activate the PDCP duplication transmission mechanism and activate path #2 (corresponding path number is R₂) and path #1 (corresponding path number is R₁), the D/C may be set to indicate a control PDU, the PDU type may be set to 100, the DA (activation/deactivation indication) may be set to 1, and configurations corresponding to R₂ and R₁ may be set to 1. After receiving the control PDU, the remote terminal may activate path #2 and path #1 for duplicate transmission.

### Scheme 3

In Scheme 3, the remote terminal may activate/deactivate the PDCP duplication transmission mechanism according to a per-hop control signalling from the relay terminal.

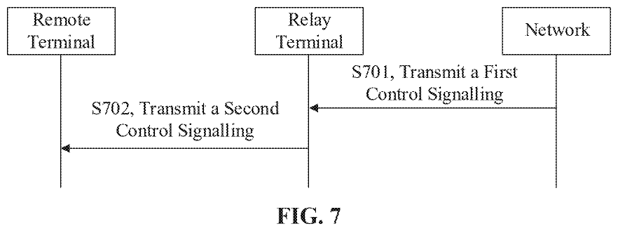

In some embodiments, the per-hop control signalling from the relay terminal may be triggered by a network control. As shown in FIG. 7, in S701, a network may transmit a control signalling (for example, denoted as a first control signalling) to a relay terminal. The first control signalling is a PDCP duplication transmission activation/deactivation instruction for a remote terminal. After receiving the first control signalling, the relay terminal may set a control signalling (for example, denoted as a second control signalling) on a PC5 interface between the relay terminal and the remote terminal according to the first control signalling. In S702, the relay terminal may transmit the second control signalling to the remote terminal.

In a first implementation, the control signalling may be a MAC CE.

In some embodiments, the network may autonomously select which relay terminal(s) on which path(s) the MAC CE (first control signalling) is transmitted to. For example, the network may transmit the MAC CE to a relay terminal on a primary path. That is, the network may transmit the MAC CE over the primary path. As another example, the network may transmit the MAC CE to a relay terminal on a secondary path. That is, the network may transmit the MAC CE over the secondary path. As yet another example, the network may transmit the MAC CE to the relay terminals on the primary path and the secondary path. That is, the network may transmit the MAC CE through the primary path and the secondary path. For example, in the scenario shown in FIG. 4, the network (gNB) may select to transmit the MAC CE to one of the relay terminal #1 and the relay terminal #2, or the network may transmit the MAC CE to both the relay terminal #1 and the relay terminal #2.

In some embodiments, information to be included in the MAC CE from the network to the relay terminal includes: whether the duplication transmission is required to be activated for the DRB; an ID of a remote terminal (e.g., L2 ID or local UE ID) for which the duplication transmission is required to be activated.

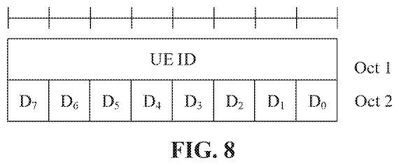

Whether the duplication transmission is required to be activated for the DRB may be indicated, for example, by means of a bitmap. For example, in a format of a MAC CE (an example of the first control signalling) shown in FIG. 8, D₀ to D₇ each correspond to one respective DRB. When one or more of values of DO to D7 are set to 1, it indicates that the corresponding DRB is activated. As shown in FIG. 8, the MAC CE may also include a UE ID (i.e., an ID of a remote terminal for which the duplicate transmission is required to be activated).

After receiving the MAC CE from the network, the relay terminal may set a MAC CE (second control signalling) on a PC 5 interface between the relay terminal and a remote terminal according to the MAC CE. Information to be included in the MAC CE from the relay terminal to the remote terminal includes: a DRB index or ID (by means of bitmap) for which the duplication transmission is required to be activated. For a possible format of the MAC CE from the relay terminal to the remote terminal, for example, a format of an existing PDCP duplication activation/deactivation MAC CE may be reused.

After receiving the MAC CE from the relay terminal, the remote terminal may activate/deactivate the duplication transmission of the corresponding DRB according to the indication of whether or not the duplication transmission is activated for each DRB in the MAC CE.

In a second implementation, the control signalling may be an RLC control PDU or an SRAP control PDU.

In some embodiments, the network may autonomously select which relay terminal(s) on which path(s) the RLC control PDU or the SRAP control PDU (first control signalling) is transmitted to. For example, the network may transmit the RLC control PDU or the SRAP control PDU to a relay terminal on a primary path. That is, the network may transmit the RLC control PDU or the SRAP control PDU over the primary path. As another example, the network may transmit the RLC control PDU or the SRAP control PDU to a relay terminal on a secondary path. That is, the network may transmit the RLC control PDU or the SRAP control PDU over the secondary path. As yet another example, the network may transmit the RLC control PDU or the SRAP control PDU to the relay terminals on the primary path and the secondary path. That is, the network may transmit the RLC control PDU or the SRAP control PDU over the primary path and the secondary path. For example, in the scenario shown in FIG. 4, the network (gNB) may select to transmit the RLC control PDU or the SRAP control PDU to one of the relay terminal #1 and the relay terminal #2, or the network may transmit the RLC control PDU or the SRAP control PDU to both the relay terminal #1 and the relay terminal #2.

In some embodiments, information to be included in the RLC control PDU or the SRAP control PDU from the network to the relay terminal includes: an ID (L2 ID or local UE ID) of the remote terminal for which the duplication transmission is required to be activated; a DRB index or ID for which the duplication transmission is required to be activated; an activation/deactivation indication.

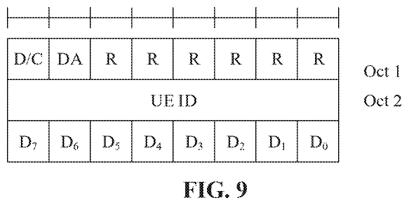

FIG. 9 shows one possible format of an RLC control PDU or an SRAP control PDU transmitted by the network. As shown in FIG. 9, the RLC control PDU or the SRAP control PDU may include the following parameters:

D/C: used to indicate whether it is data or a control PDU; activation/deactivation indication (denoted by DA); DO to D7 (DRB index or ID); UE ID (an ID of a remote terminal for which the duplication transmission is required to be activated). R in FIG. 9 represents a padding bit.

After receiving the RLC control PDU or the SRAP control PDU from the network, the relay terminal may set a RLC control PDU or a SRAP control PDU (second control signalling) on the PC5 interface between the relay terminal and a remote terminal according to the RLC control PDU or the SRAP control PDU.

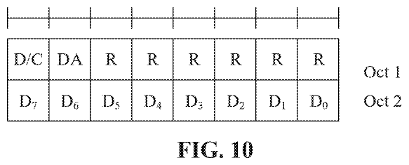

FIG. 10 shows one possible format of an RLC control PDU or an SRAP control PDU transmitted by a relay terminal. As shown in FIG. 10, the RLC control PDU or the SRAP control PDU may include the following parameters:

D/C: used to indicate whether it is data or a control PDU; activation/deactivation indication (denoted by DA); DO to D7 (DRB index or ID). R in FIG. 10 represents a padding bit.

After receiving the RLC control PDU or the SRAP control PDU from the relay terminal, the remote terminal may activate/deactivate the duplication transmission of the corresponding DRB according to an indication of whether or not the duplication transmission is activated for respective DRBs in the RLC control PDU or the SRAP control PDU.

According to the method of the embodiments of the present application, in a scenario in which each path between the remote terminal and the network is a non-direct path, dynamic activation of the PDCP duplication transmission mechanism is supported.

In some embodiments, the embodiments of the present application may also be applied to a U2U relay scenario. That is, in a scenario where each path between a remote terminal and another remote terminal is a non-direct path, dynamic activation of the PDCP duplication transmission mechanism is supported.

In some embodiments, in a non-duplicate transmission scenario, which path should be used for a split-bearer may be dynamically determined according to QoS requirements (such as a PDB, a PER, etc.) and path conditions of each path (such as the number of relay hops, a level of congestion, a signal quality, etc.). For example, for the data to be transmitted, if the required PDB is low, a path with fewer relay hops may be selected, if the PER is required to be low (that is, the transmission reliability is required to be high), a path with better signal quality may be selected.

The preferred embodiments of the present application have been described in detail above with reference to the accompanying drawings, but the present application is not limited to the specific details in the above-described embodiments. Within the scope of the technical concept of the present application, various simple modifications can be made to the technical solutions of the present application, and these simple modifications all fall within the scope of the present application. For example, various specific technical features described in the above-described detailed description can be combined in any suitable manner without contradiction, and various possible combinations will not be described separately in this application in order to avoid unnecessary repetition. For example, various implementations of the present application may be combined arbitrarily, and as long as they do not violate the idea of the present application, they should also be regarded as the disclosure of the present application. For another example, on the premise that there is no conflict, each embodiment described in the present application and/or the technical features in each embodiment can be arbitrarily combined with the prior art, and the technical solution obtained after the combination should also fall within the scope of the present application.

It should also be understood that in various method embodiments of the present application, the size of the sequence number of the above-described processes does not mean the sequence of execution, and the sequence of execution of each process should be determined by its function and internal logic, and should not constitute any limitation on the implementation process of the embodiments of the present application. In addition, in the embodiments of the present application, the terms “downlink”, “uplink”, and “sidelink” are used to indicate the transmission direction of signals or data. The term “downlink” is used to indicate that the transmission direction of signals or data is a first direction transmitted from a site to a user device of a cell. The term “uplink” is used to indicate that the transmission direction of signals or data is a second direction transmitted from a user device of a cell to a site. The term “sidelink” is used to indicate that the transmission direction of signals or data is a third direction transmitted from a user device 1 to a user device 2. For example, “downlink signal” indicates that the transmission direction of the signal is the first direction. In addition, in the embodiments of the present application, the term “and/or” is only one kind of association relationship describing association objects, and indicates that there may be three kinds of relationships. Specifically, A and/or B may represent any one of three cases: A alone, both A and B, and B alone. In addition, the character “/” herein generally indicates that the related objects before the character “/” and after the character “/” are in an “or” relationship.

Based on the foregoing embodiments, embodiments of the present application provide corresponding duplicate transmission apparatuses.

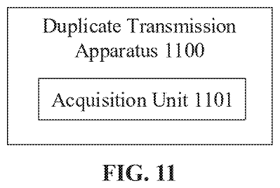

FIG. 11 is a schematic structural diagram of a duplication transmission apparatus according to an embodiment of the present application, and the duplication transmission apparatus is applied to the first device. There are one or multiple paths between the duplicate transmission apparatus 1100 and a second device, and there are one or more relay terminal devices on each path. As shown in FIG. 11, the duplication transmission apparatus 1100 (hereinafter simply referred to as the apparatus 1100) includes an acquisition unit 1101.

The acquisition unit 1101 is configured to acquire first information, the first information is used to determine whether to activate a packet data convergence protocol (PDCP) duplication transmission mechanism of the apparatus 1100, and the PDCP duplication transmission mechanism is used for the apparatus 1100 to transmit the first data to the second device.

In some embodiments, the first information is from an upper layer of the apparatus 1100, and the first information is used to indicate: whether to activate the PDCP duplication transmission mechanism; or activating the PDCP duplication transmission mechanism in a case that the first data is of a specific service type.

In some embodiments, the first information includes a packet error rate (PER), and when the PER is less than or equal to the first threshold, the PDCP duplication transmission mechanism is activated.

In some embodiments, the first threshold is related to one or more of the following information: a first quality of service (QoS) parameter; a first measured value; a number of the relay terminal devices; a manner in which the apparatus 1100 acquires transmission resources; or, a radio link control (RLC) mode.

In some embodiments, multiple paths exist between the apparatus 1100 and the second device, and the first information includes: a data transmission result received by the apparatus 1100 over a first path of the multiple paths within a first time period. The data transmission result is from a first relay terminal device on the first path, and the first relay terminal device is directly connected to the apparatus 1100.

In some embodiments, one path exists between the apparatus 1100 and the second device, and the first information includes: a data transmission result received by the apparatus 1100 over the path within a first time period. The data transmission result is from a first relay terminal device on the path, and the first relay terminal device is directly connected to the device 1100.

In some embodiments, the PDCP duplication transmission mechanism is activated in a case that a first condition is met. The first condition includes that: the data transmission result includes a first number of consecutive non-positive feedbacks; or, the data transmission result includes a first number of non-positive feedbacks.

In some embodiments, multiple paths exist between the apparatus 1100 and the second device, and the first information includes: data transmission results respectively received by the apparatus 1100 on at least two of the multiple paths within a first time period. The data transmission result received by the apparatus 1100 over each of the at least two paths is from a first relay terminal device on the path, the first relay terminal device is directly connected to the apparatus 1100.

In some embodiments, the PDCP duplication transmission mechanism is activated in a case that a second condition is met. The second condition includes that: each of the data transmission results includes a first number of consecutive non-positive feedbacks; or, each of the data transmission results includes a first number of non-positive feedbacks; or, a sum of the number of consecutive non-positive feedbacks included in each of the data transmission results reaches a first number; or, a sum of the number of non-positive feedbacks included in each of the data transmission results reaches a first number.

In some embodiments, the first number relates to one or more of the following information: a PER; a first QoS parameter; a first measured value; a number of relay terminal devices; a manner in which the apparatus 1100 acquires transmission resources; or, a RLC mode.

In some embodiments, the first time period is related to one or more of the following information: a PER; a first QoS parameter; a first measured value; a number of relay terminal devices; a manner in which the apparatus 1100 acquires transmission resources; or, a RLC mode.

In some embodiments, the data transmission result is a hybrid automatic retransmission request feedback result or an RLC feedback result.

In some embodiments, the first information includes a data transmission result from the second device, and the data transmission result is used to determine an amount of lost data in data transmitted by the apparatus 1100 to the second device.

In some embodiments, the PDCP duplication transmission mechanism is activated in a case that the amount of the lost data is greater than or equal to a second threshold.

In some embodiments, the second threshold is related to one or more of the following information: a PER; a first QoS parameter; a first measured value; a number of relay terminal devices; a manner in which the apparatus 1100 acquires transmission resources; or, a RLC mode.

In some embodiments, the data transmission result is a PDCP status report.

In some embodiments, the first information includes an amount of data included in one or more of a PDCP layer, an RLC layer, and a media access control (MAC) layer of the apparatus 1100.

In some embodiments, the PDCP duplication transmission mechanism is activated in a case that the amount of data is less than or equal to a third threshold.

In some embodiments, the third threshold is related to one or more of the following information: a PER; a first QoS parameter; a first measured value; a number of relay terminal devices; a manner in which the apparatus 1100 acquires transmission resources; or, a RLC mode.

In some embodiments, the first QoS parameter includes: a priority of the first data; and/or a package delay budget, and the first measured value includes: a level of congestion of a resource pool; and/or a signal quality.

In some embodiments, the first data is a first data radio bearer (DRB), and the PER is a minimum value, a maximum value, or an average value of PERs in QoS flows associated with the first DRB.

In some embodiments, multiple paths exist between the apparatus 1100 and the second device, and at least two of the multiple paths are used for the apparatus 1100 to transmit the first data to the second device in a case that the PDCP duplication transmission mechanism is activated, the at least two paths are determined by the apparatus 1100.

In some embodiments, the first information is used to indicate whether to activate the PDCP duplication transmission mechanism; or, in a case that multiple paths exist between the apparatus 1100 and the second device, the first information is used to indicate activating the PDCP duplication transmission mechanism, and at least two of the multiple paths, the at least two paths are used for the apparatus 1100 to transmit the first data to the second device.

In some embodiments, the first information is a PDCP control protocol data unit from the second device.

In some embodiments, the first data includes one or more DRBs, and the first information is used to indicate: activating or deactivating the PDCP duplication transmission mechanism; and the one or more DRBs.

In some embodiments, the first information is determined based on second information from the second device, the second information is used to indicate: an identifier of the apparatus 1100; activating or deactivating the PDCP duplication transmission mechanism; and the one or more DRBs.

In some embodiments, the first information is a MAC control unit, an RLC control protocol data unit, or a sidelink relay adaptation protocol (SRAP) control protocol data unit from at least one first relay terminal device, the at least one first relay terminal device is respectively located on at least one path between the apparatus 1100 and the second apparatus, and the at least one first relay terminal device is directly connected to the apparatus 1100.

In some embodiments, the apparatus 1100 is a terminal device, and the second device is a network device or a terminal device.

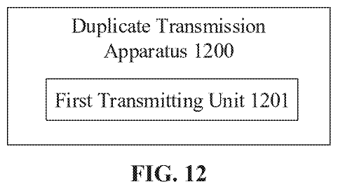

FIG. 12 is a second schematic structural diagram of a duplicate transmission apparatus provided by an embodiment of the present application. The duplicate transmission apparatus is applied to a second device. There are one or multiple paths between a first device and the duplicate transmission apparatus 1200, and there are one or more relay terminal devices on each path. As shown in FIG. 12, the duplication transmission apparatus 1200 (hereinafter simply referred to as the apparatus 1200) includes a first transmitting unit 1201.

The first transmitting unit 1201 is configured to transmit first information to the first device, the first information is used to determine whether to activate a packet data convergence protocol (PDCP) duplication transmission mechanism of the first device, and the PDCP duplication transmission mechanism is used for the first device to transmit first data to the apparatus 1200.

In some embodiments, the first information includes a data transmission result, the data transmission result is used to determine an amount of lost data in data transmitted by the first device to the apparatus 1200.

In some embodiments, the PDCP duplication transmission mechanism is activated in a case that the amount of the lost data is greater than or equal to a second threshold.

In some embodiments, the second threshold is related to one or more of the following information: a packet error rate (PER); a first quality of service (QoS) parameter; a first measured value; a number of the relay terminal devices; a manner in which the first device acquires transmission resources; or, an radio link control (RLC) mode.

In some embodiments, the first data is a first data radio bearer (DRB), and the PER is a minimum value, a maximum value, or an average value of PERs in QoS flows associated with the first DRB; the first QoS parameter includes: a priority of the first data and/or a package delay budget; the first measured value includes: a level of congestion of a resource pool and/or a signal quality.

In some embodiments, the data transmission result is a PDCP status report.

In some embodiments, the first information is used to indicate whether to activate the PDCP duplication transmission mechanism; or, in a case that multiple paths exist between the first device and the apparatus 1200, the first information is used to indicate activating the PDCP duplication transmission mechanism, and at least two of the multiple paths, the at least two paths are used for the first device to transmit the first data to the apparatus 1200.

In some embodiments, the first information is a PDCP control protocol data unit.

In some embodiments, the first device is a terminal device, and the apparatus 1200 is a network device or a terminal device.

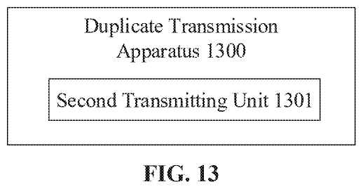

FIG. 13 is a third schematic structural diagram of a duplication transmission apparatus according to an embodiment of the present application, and the duplication transmission apparatus is applied to the first relay terminal device. The duplicate transmission device 1300 is located on a first path between a first device and a second device. The duplicate transmission device 1300 is directly connected to the first device, there are one or multiple paths between the first device and the second device, and there are one or more relay terminal devices on each path. As shown in FIG. 13, the duplication transmission apparatus 1300 (hereinafter simply referred to as the apparatus 1300) includes a second transmission unit 1301.

The second transmission unit 1301 is configured to transmit first information to the first device, the first information is used to determine whether to activate a packet data convergence protocol (PDCP) duplication transmission mechanism of the first device, and the duplication transmission mechanism is used for the first device to transmit first data to the second device.

In some embodiments, the first information includes a data transmission result within a first time period.

In some embodiments, the PDCP duplication transmission mechanism is activated in a case that a first condition is met, the first condition includes that: the data transmission result includes a first number of consecutive non-positive feedbacks; or, the data transmission result includes a first number of non-positive feedbacks.

In some embodiments, the first number is related to one or more of the following information: a packet error rate (PER); a first quality of service (QoS) parameter; a first measured value; a number of the relay terminal devices; a manner in which the first device acquires transmission resources; or, an radio link control (RLC) mode.

In some embodiments, the first time period is related to one or more of the following information: a PER; a first QoS parameter; a first measured value; a number of relay terminal devices; a manner in which the first device acquires transmission resources; or, a RLC mode.

In some embodiments, the first data is a first data radio bearer (DRB), and the PER is a minimum value, a maximum value, or an average value of PERs in QoS flows associated with the first DRB; the first QoS parameter includes: a priority of the first data and/or a package delay budget; and the first measured value includes: a level of congestion of a resource pool and/or a signal quality.

In some embodiments, the data transmission result is a hybrid automatic retransmission request feedback result or an RLC feedback result.

In some embodiments, the first data includes one or more DRBs, the first information is used to indicate: activating or deactivating the PDCP duplication transmission mechanism; and the one or more DRBs.

In some embodiments, the first information is determined based on second information from the second device, the second information is used to indicate: an identifier of the first device; activating or deactivating the PDCP duplication transmission mechanism; and the one or more DRBs.

In some embodiments, the first information is a MAC control unit, an RLC control protocol data unit, or a sidelink relay adaptation protocol (SRAP) control protocol data unit.

In some embodiments, the first device is a terminal device, and the second device is a network device or a terminal device.

Those skilled in the art should understand that the related description of the above-described duplicate transmission apparatuses according to the embodiments of the present application can be understood with reference to the related description of the duplication transmission methods according to the embodiments of the present application.

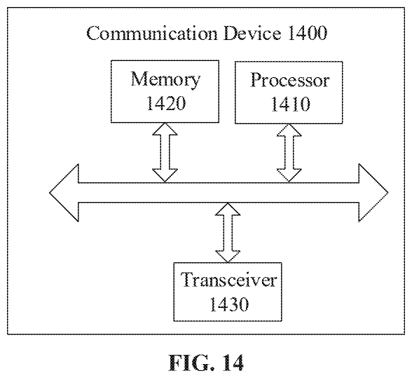

FIG. 14 is a schematic structural diagram of a communication device 1400 according to an embodiment of the present application. The communication device 1400 illustrated in FIG. 14 includes a processor 1410. The processor 1410 can invoke and execute a computer program from a memory to implement the methods in the embodiments of the present application.

Optionally, as shown in FIG. 14, the communication device 1400 may further include a memory 1420. The processor 1410 may invoke and execute a computer program from the memory 1420 to implement the methods in the embodiments of the present application.

The memory 1420 may be a separate device independent of the processor 1410 or may be integrated in the processor 1410.

Optionally, as shown in FIG. 14, the communication device 1400 may further include a transceiver 1430, and the processor 1410 may control the transceiver 1430 to communicate with other devices, specifically, to transmit information or data to other devices, or receive information or data transmitted by other devices.

Here, the transceiver 1430 may include a transmitter and a receiver. The transceiver 1430 may further include antennas, and the number of antennas may be one or more.

Optionally, the communication device 1400 may specifically be the first device according to the embodiments of the present application, and the communication device 1400 may implement corresponding processes implemented by the first device in each method according to the embodiments of the present application, and will not be described herein for the sake of brevity.

Optionally, the communication device 1400 may specifically be the second device of the embodiments of the present application, and the communication device 1400 may implement corresponding processes implemented by the second device in each method of the embodiments of the present application, and will not be described herein for the sake of brevity.

Optionally, the communication device 1400 may specifically be the first relay terminal device according to the embodiments of the present application, and the communication device 1400 may implement corresponding processes implemented by the first relay terminal device in each method according to the embodiments of the present application, and will not be described herein for the sake of brevity.

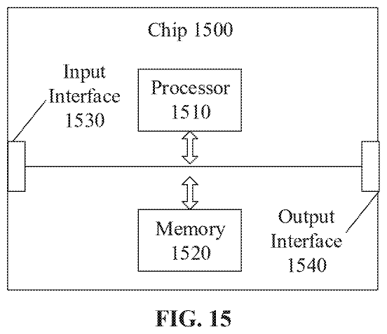

FIG. 15 is a schematic structural diagram of a chip according to an embodiment of the present application. The chip 1500 shown in FIG. 15 includes a processor 1510, which can invoke and execute a computer program from a memory to implement the methods in the embodiments of the present application.

Optionally, as shown in FIG. 15, the chip 1500 may further include a memory 1520. The processor 1510 may invoke and execute a computer program from the memory 1520 to implement the methods in the embodiments of the present application.

The memory 1520 may be a separate device independent of the processor 1510 or may be integrated in the processor 1510.

Optionally, the chip 1500 may further include an input interface 1530. The processor 1510 may control the input interface 1530 to communicate with other devices or chips, specifically, to acquire information or data transmitted by other devices or chips.

Optionally, the chip 1500 may further include an output interface 1540. The processor 1510 may control the output interface 1540 to communicate with other devices or chips, specifically, to output information or data to other devices or chips.

Optionally, the chip can be applied to the first device in the embodiments of the present application, and the chip can implement corresponding processes implemented by the first device in each method of the embodiments of the present application, and will not be repeatedly described here for the sake of brevity.

Optionally, the chip can be applied to the second device in the embodiments of the present application, and the chip can implement corresponding processes implemented by the second device in each method of the embodiments of the present application, and will not be repeatedly described here for the sake of brevity.

Optionally, the chip can be applied to the first relay terminal device in the embodiments of the present application, and the chip can implement corresponding processes implemented by the first relay terminal device in each method of the embodiments of the present application, and will not be repeatedly described here for the sake of brevity.

It should be understood that the chip mentioned in the embodiments of the present application may also be referred to as a system level chip, a system chip, a chip system, a system-on-chip chip, etc.

It should be understood that the processor of the embodiments of the present application may be an integrated circuit chip having signal processing capabilities. In the implementation process, the steps of the above-described method embodiments may be completed by integrated logic circuits in hardware in the processor or instructions in the form of software. The processor described above may be a general-purpose processor, a Digital Signal Processor (DSP), an Application Specific Integrated Circuit (ASIC), an Field Programmable Gate Array (FPGA) or other programmable logic device, a discrete gate or transistor logic device, or a discrete hardware component. The methods, steps, and logical block diagrams disclosed in the embodiments of the present application may be implemented or executed. The general purpose processor may be a microprocessor or the processor may be any conventional processor or the like. The steps of the method disclosed in connection with the embodiments of the present application may be directly embodied as execution by the hardware decoding processor, or may be executed through a combination of hardware and software modules in the decoding processor. The software module may be located in a storage medium mature in the art, such as a random access memory, a flash memory, a read-only memory, a programmable read-only memory, or an electrically erasable and programmable memory, a register, etc. The storage medium is located in the memory, and the processor reads the information in the memory, and completes the steps of the above method in combination with its hardware.

It is understood that the memory in the embodiments of the present application may be a volatile memory or a non-volatile memory, or may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration, but not by way of limitation, many forms of RAM are available, such as a Static RAM (SRAM), Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory of the systems and methods described herein is intended to include, but is not limited to, these and any other suitable type of memory.

It should be understood that the above memory is illustrative but not limiting, for example, the memory in the embodiments of the present application may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Direct Rambus RAM (DR RAM), and the like. That is, the memory in the embodiments of the present application is intended to include, but is not limited to, these and any other suitable type of memory.

Embodiments of the present application also provide a computer-readable storage medium for storing a computer program.

Optionally, the computer-readable storage medium can be applied to the first device in the embodiments of the present application, and the computer program causes a computer to execute the corresponding procedures implemented by the first device in each method in the embodiments of the present application, and the description thereof is not repeated here for the sake of brevity.

Optionally, the computer-readable storage medium can be applied to the second device in the embodiments of the present application, and the computer program causes a computer to execute the corresponding procedures implemented by the second device in each method of the embodiments of the present application, and will not be repeated here for the sake of brevity.

Optionally, the computer-readable storage medium can be applied to the first relay terminal device in the embodiments of the present application, and the computer program causes a computer to execute the corresponding procedures implemented by the first relay terminal device in each method of the embodiments of the present application, and the description thereof will not be repeated here for the sake of brevity.

Embodiments of the present application also provide a computer program product including computer program instructions.

Optionally, the computer program product can be applied to the first device in the embodiments of the present application, and the computer program instructions cause a computer to execute the corresponding procedures implemented by the first device in each method of the embodiments of the present application, and will not be repeated here for the sake of brevity.

Optionally, the computer program product can be applied to the second device in the embodiments of the present application, and the computer program instruction causes a computer to execute the corresponding procedures implemented by the second device in each method of the embodiments of the present application, and will not be repeated here for the sake of brevity.

Optionally, the computer program product can be applied to the first relay terminal device in the embodiments of the present application, and the computer program instruction causes a computer to execute the corresponding procedures implemented by the first relay terminal device in each method of the embodiments of the present application, and the description thereof is not repeated here for the sake of brevity.

Embodiments of the present application also provide a computer program.

Optionally, the computer program can be applied to the first device in the embodiments of the present application, and the computer program, when executed on a computer, causes the computer to execute the corresponding procedures implemented by the first device in each method of the embodiments of the present application, which is not repeated here for the sake of brevity.

Optionally, the computer program can be applied to the second device in the embodiments of the present application, and the computer program when executed on a computer, causes the computer to execute the corresponding procedures implemented by the second device in each method of the embodiments of the present application, which is not repeated here for the sake of brevity.

Optionally, the computer program can be applied to the first relay terminal device in the embodiments of the present application, and the computer program, when executed on the computer, causes the computer to execute the corresponding procedures implemented by the first relay terminal device in each method of the embodiments of the present application, which is not repeated here for the sake of brevity.

In the method, there is one or multiple paths between a first device and a second device, and there are one or more relay terminal devices on each path. The first device may acquire first information, and thereby may determine whether to activate a PDCP duplication transmission mechanism of the first device based on the first information, and the PDCP duplication transmission mechanism may be used for the first device to transmit first data to the second device. In this way, the activation control of the PDCP duplication transmission mechanism of the first device can be realized in a case that each path between the first device and the second device is a non-direct path.

Those of ordinary skill in the art will appreciate that the elements and algorithmic steps of the various examples described in connection with the embodiments disclosed herein can be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the present application.

Those skilled in the art can clearly understand that for convenience and conciseness of the description, the specific operating processes of the systems, devices, and units described above may refer to the corresponding processes in the aforementioned method embodiments, and will not be repeatedly described herein.

In several embodiments provided herein, it should be understood that the disclosed systems, apparatuses, and methods may be implemented in other ways. For example, the device embodiments described above are merely schematic. For example, the division of units is only one logical function division, and there may be other division methods in actual implementation. For example, multiple units or components may be combined or integrated into another system, or some features may be ignored or not implemented. In addition, the coupling or direct coupling or communication connection between devices or units shown or discussed may be an indirect coupling or communication connection through some interface, which may be electrical, mechanical or otherwise.

The units described as separate units may or may not be physically separate, and the units displayed as units may or may not be physical units, that is, they may be located in one place or may be distributed over a plurality of network units. Some or all of the units may be selected according to actual needs to achieve the purpose of the solution of the present embodiment.

In addition, each functional unit in each embodiment of the present application may be integrated in one processing unit, each unit may be physically present alone, or two or more units may be integrated in one unit.

The functions may be stored in a computer-readable storage medium if implemented in the form of software functional units and sold or used as independent products. Based on this understanding, the technical solution of the present application essentially or a part that contributes to the prior art or a part of the technical solution may be embodied in the form of a software product, which is stored in a storage medium and includes several instructions for causing a computer device (which may be a personal computer, a server, or a network device, etc.) to perform all or part of the steps of the methods described in various embodiments of the present application. The storage medium includes various medium that can store program codes, such as a USB disk, a removable hard disk, a Read-Only Memory (ROM), a Random Access Memory (RAM), a magnetic disk, or an optical disk.

The above is merely specific embodiments of the present application, but the scope of the present application is not limited thereto, and any changes or alternatives which can be easily thought by a person skilled in the art within the technical scope disclosed in the present application should be covered within the scope of the present application. Therefore, the scope of the present application should be based on the scope of the claims.

1. A duplication transmission method, applied to a first device, one or multiple paths existing between the first device and a second device, one or more relay terminal devices existing on each path, the method comprising:
acquiring first information, the first information being used to determine whether to activate a packet data convergence protocol (PDCP) duplication transmission mechanism of the first device, the PDCP duplication transmission mechanism being used for the first device to transmit first data to the second device.

2. The method of claim 1, wherein
more than one path exists between the first device and the second device and in a case that the PDCP duplication transmission mechanism is activated, at least two of the more than one path are used for the first device to transmit the first data to the second device, the at least two paths are determined by the first device.

3. The method of claim 1, wherein
the first information is used to indicate whether to activate the PDCP duplication transmission mechanism; or,
in a case that multiple paths exist between the first device and the second device, the first information is used to indicate activating the PDCP duplication transmission mechanism and at least two of the multiple paths, the at least two paths are used for the first device to transmit the first data to the second device.

4. The method of claim 1, wherein the first data comprises one or more DRBs,
the first information is used to indicate:
activating or deactivating the PDCP duplication transmission mechanism; and,
the one or more DRBs.

5. The method of claim 4, wherein
the first information is determined based on second information from the second device, the second information is used to indicate:
an identifier of the first device;
activating or deactivating the PDCP duplication transmission mechanism; and,
the one or more DRBs.

6. The method of claim 1, wherein
the first device is a terminal device, and the second device is a network device or a terminal device.

7. A duplication transmission method, applied to a second device, one or multiple paths existing between a first device and the second device, one or more relay terminal devices existing on each path, the method comprising:
transmitting first information to the first device, the first information being used to determine whether to activate a packet data convergence protocol (PDCP) duplication transmission mechanism of the first device, the PDCP duplication transmission mechanism being used for the first device to transmit first data to the second device.

8. The method of claim 7, wherein
the first information is used to indicate whether to activate the PDCP duplication transmission mechanism; or,
in a case that multiple paths exist between the first device and the second device, the first information is used to indicate activating the PDCP duplication transmission mechanism and at least two of the multiple paths, the at least two paths are used for the first device to transmit the first data to the second device.

9. A communication device, one or multiple paths existing between the communication device and a second device, one or more relay terminal devices existing on each path, the communication device comprising:
a processor; and
a memory for storing a computer program,
wherein the processor is configured to invoke and execute the computer program stored in the memory to acquire first information, the first information being used to determine whether to activate a packet data convergence protocol (PDCP) duplication transmission mechanism of the communication device, the PDCP duplication transmission mechanism being used for the communication device to transmit first data to the second device.

10. The communication device of claim 9, wherein
the first information is from an upper layer of the communication device, and the first information is used to indicate:
whether to activate the PDCP duplication transmission mechanism; or,
activating the PDCP duplication transmission mechanism in a case that the first data is of a specific service type.

11. The communication device of claim 9, wherein
the first information comprises a packet error rate (PER), and when the PER is less than or equal to a first threshold, the PDCP duplication transmission mechanism is activated.

12. The communication device of claim 11, wherein the first threshold is related to one or more of the following information:
a first quality of service (QoS) parameter;
a first measured value;
a number of the relay terminal devices;
a manner in which the communication device acquires transmission resources; or,
an radio link control (RLC) mode.

13. The communication device of claim 9, wherein the first information comprises:
a data transmission result from the second device, the data transmission result is used to determine an amount of lost data in data transmitted by the communication device to the second device.

14. The communication device of claim 9, wherein multiple paths exist between the communication device and the second device, the first information comprises:
data transmission results respectively received by the communication device over at least two of the multiple paths within a first time period, wherein a data transmission result received by the communication device over each of the at least two paths is from a first relay terminal device on the path, the first relay terminal device is directly connected to the communication device.

15. The communication device of claim 14, wherein the PDCP duplication transmission mechanism is activated in a case that a second condition is met, the second condition comprises:
each of the data transmission results comprising a first number of consecutive non-positive feedbacks; or,
each of the data transmission results comprising a first number of non-positive feedbacks; or,
a sum of the number of consecutive non-positive feedbacks comprised in each of the data transmission results reaches a first number; or,
a sum of the number of non-positive feedbacks comprised in each of the data transmission results reaches a first number.

16. The communication device of claim 9, wherein
more than one path exists between the communication device and the second device and in a case that the PDCP duplication transmission mechanism is activated, at least two of the more than one path are used for the communication device to transmit the first data to the second device, the at least two paths are determined by the communication device.

17. The communication device of claim 9, wherein
the first information is used to indicate whether to activate the PDCP duplication transmission mechanism; or,
in a case that multiple paths exist between the communication device and the second device, the first information is used to indicate activating the PDCP duplication transmission mechanism and at least two of the multiple paths, the at least two paths are used for the communication device to transmit the first data to the second device.

18. The communication device of claim 9, wherein the first data comprises one or more DRBs,
the first information is used to indicate:
activating or deactivating the PDCP duplication transmission mechanism; and,
the one or more DRBs.

19. The communication device of claim 18, wherein
the first information is determined based on second information from the second device, the second information is used to indicate:
an identifier of the communication device;
activating or deactivating the PDCP duplication transmission mechanism; and,
the one or more DRBs.

20. The communication device of claim 9, wherein
the communication device is a terminal device, and the second device is a network device or a terminal device.
